(19) United States
(12) Patent Application Publication
(10) Pub. No.: US 2026/0368780 A1
(43) Pub. Date: Nov. 19, 2026

(54) SYSTEMS AND METHODS FOR CREATING ADVERTISEMENT INVENTORY

(71) Applicant: Verizon Patent and Licensing Inc., Basking Ridge, NJ (US)

(72) Inventors: Glenn ALTCHEK, Lawrenceville, NJ (US); Shashank Shekhar SHARMA, Dallas, TX (US); Ramesh Naidu BHEEMARASETTY, Little Elm, TX (US); Aakash CHOKSHI, Livingston, NJ (US)

(73) Assignee: Verizon Patent and Licensing Inc., Basking Ridge, NJ (US)

(21) Appl. No.: 19/211,831

(22) Filed: May 19, 2025

(51) Int. Cl. G06Q 30/0272; G06Q 30/0242; G06Q 30/0251

(52) U.S. Cl. CPC G06Q 30/0272; G06Q 30/0242; G06Q 30/0251

(57) ABSTRACT

A device may receive advertisement inventory data associated with a content broadcast and including a plurality of advertisement slots. The device may identify, from the plurality of advertisement slots, a set of advertisement slots having durations of first lengths and being designated as unsold or sold below a threshold value. The device may select at least two consecutive advertisement slots within an advertisement break and from the set of advertisement slots, and may merge the at least two consecutive advertisement slots to form a second length advertisement slot. The device may allocate the second length advertisement slot for advertising.

### BACKGROUND

Targeted advertising relates to the distribution of advertisements to specific audiences based on various criteria. This practice can be applied across different platforms and systems to deliver advertisements in a tailored manner.

### BRIEF DESCRIPTION OF THE DRAWINGS

FIGS. 1A-1G are diagrams of an example associated with creating advertisement inventory.

FIG. 2 is a diagram of an example environment in which systems and/or methods described herein may be implemented.

FIG. 3 is a diagram of example components of one or more devices of FIG. 2.

FIG. 4 is a flowchart of an example process for creating advertisement inventory.

### DETAILED DESCRIPTION OF EXAMPLE EMBODIMENTS

The following detailed description of example implementations refers to the accompanying drawings. The same reference numbers in different drawings may identify the same or similar elements.

The distribution of video and audio content often involves agreements between content providers and distributors, such as cable or pay-television operators, which allow the insertion of local advertisements during designated advertisement breaks. These advertisement breaks are typically scheduled for fixed durations, such as sixty seconds, and are divided into smaller segments, or slots, that can accommodate advertisements of varying lengths. Distributors rely on these advertisement slots to generate revenue by selling advertisement space to advertisers or by using the advertisement slots for their own marketing purposes. However, the allocation and utilization of these advertisement slots are governed by complex constraints, including contractual requirements, viewer experience considerations, and market-specific sales agreements.

Despite the flexibility offered by shorter advertisement durations, the demand for sixty-second advertisement slots has risen significantly in recent years from particular advertisers. These particular advertisers require extended time slots to include more information (e.g., regulatory statements, legal statements, and/or the like) as part of their advertisements. Creating sixty-second advertisement slots within the existing inventory is challenging because most advertisement slots are sold in shorter durations (e.g., typically thirty second advertisement slots). Moreover, addressable advertising (e.g., a technique that targets specific demographics with tailored ads) has become increasingly valuable as it enables distributors to maximize the relevance and effectiveness of advertisements. However, the limited availability of sixty-second advertisement slots constrains distributors' ability to meet the growing demand for longer, addressable advertisements (e.g., pharmaceutical advertisements), resulting in lost revenue opportunities.

Efforts to address these challenges are further complicated by the need to maintain compliance with sales agreements, preserve viewer experience by avoiding back-to-back marketing advertisements, and provide accurate post-play verification to advertisers and sales partners. These competing requirements make it difficult to efficiently manage and optimize advertisement inventory for longer-duration addressable advertisements, thereby hindering the ability of distributors to fully capitalize on high-value advertising opportunities. Thus, current techniques for handling advertisement allocation consume computing resources (e.g., processing resources, memory resources, communication resources, and/or the like), networking resources, and/or other resources associated with failing to comply with sales agreements, providing a poor viewer experience for advertisements, failing to satisfy the growing demand for longer, addressable advertisements, managing fragmented advertising inventory, performing redundant validation processes, and/or the like.

Some implementations described herein provide a distribution system that creates advertisement inventory. For example, the distribution system may receive advertisement inventory data associated with a content broadcast and including a plurality of advertisement slots. The distribution system may identify, from the plurality of advertisement slots, a set of advertisement slots having durations of first lengths and being designated as unsold or sold below a threshold value. The distribution system may select at least two consecutive advertisement slots within an advertisement break and from the set of advertisement slots, and may merge the at least two consecutive advertisement slots to form a second length advertisement slot. The distribution system may allocate the second length advertisement slot for advertising. In some implementations, the advertisement for advertising may include an addressable advertisement, a digital advertisement, a programmatic advertisement, and/or the like.

In this way, the distribution system creates advertisement inventory. For example, the distribution system may address the problem of limited inventory for sixty-second advertisement slots. The distribution system may optimize the utilization of existing advertisement inventory by repurposing unsold or low-value advertisement slots (e.g., below a predetermined value), thus reducing wasted broadcasting resources. The merging and allocation of advertisement slots by the distribution system may decrease processing overhead associated with managing fragmented advertisement slots and may improve storage efficiency by consolidating metadata related to the merged advertisement slots. Furthermore, the verification and reversibility of merged advertisement slots by the distribution system may enhance the accuracy of auditing and billing processes without requiring additional processing or memory resources. Thus, the distribution system may conserve computing resources, networking resources, and/or other resources that would have otherwise been consumed by failing to comply with sales agreements, providing a poor viewer experience for advertisements, failing to satisfy the growing demand for longer, addressable advertisements, managing fragmented advertising inventory, performing redundant validation processes, and/or the like.

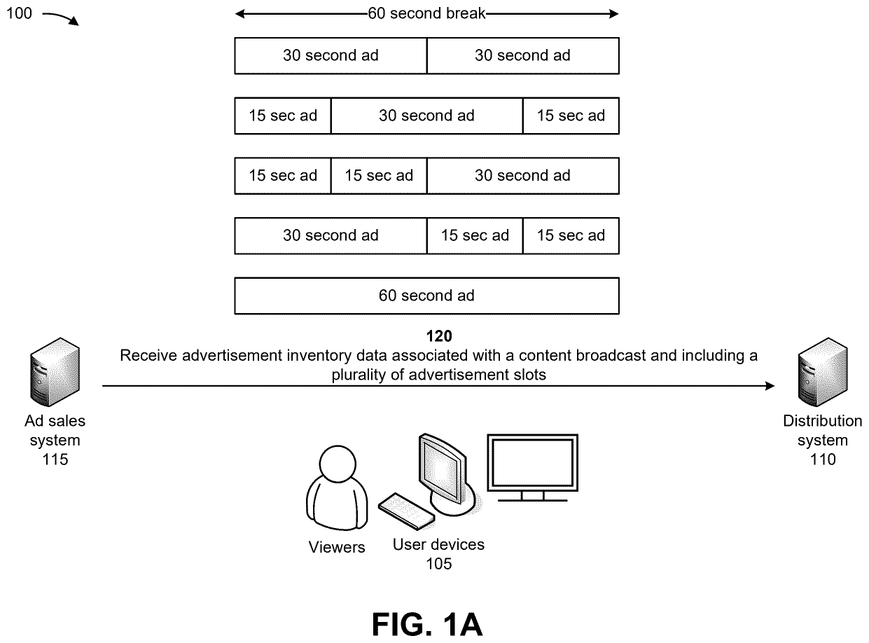

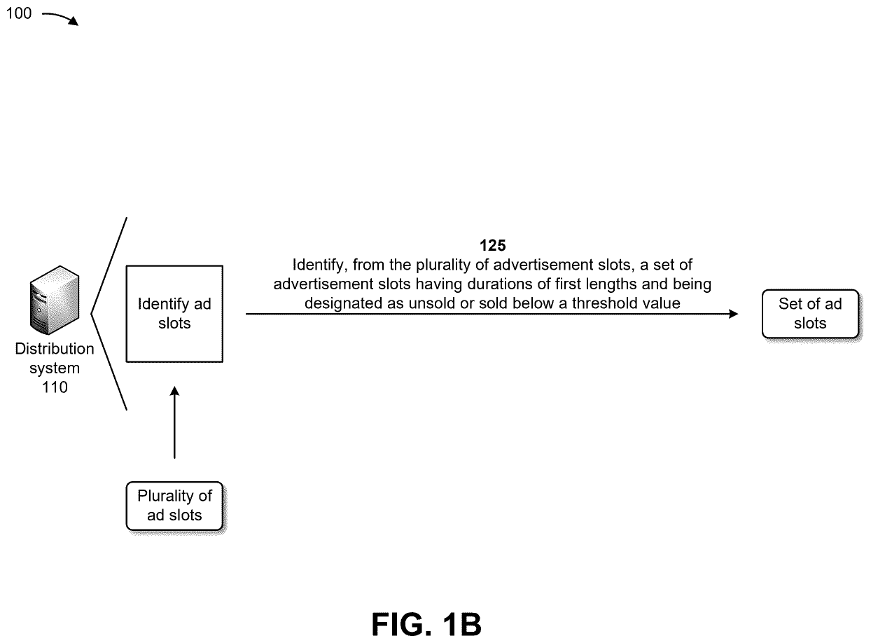

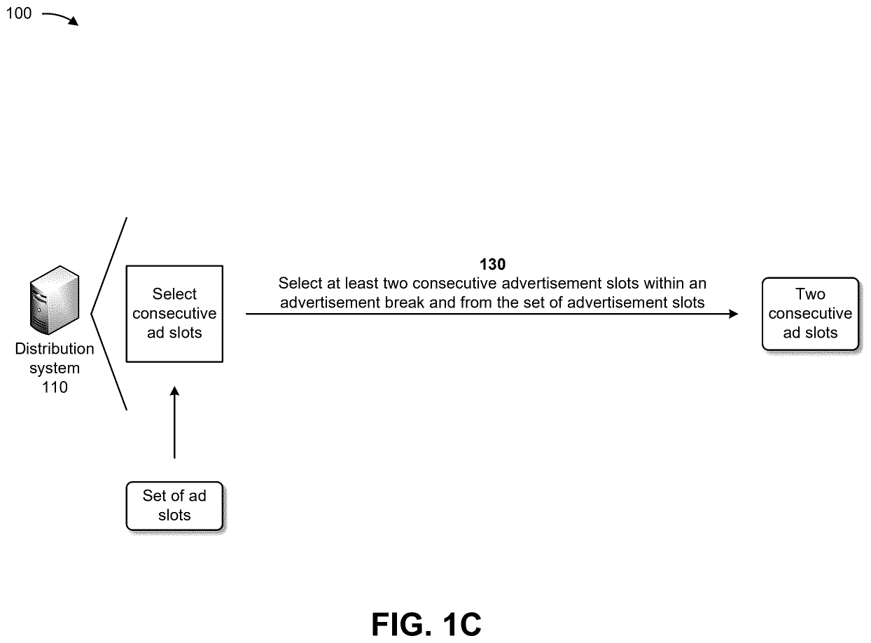

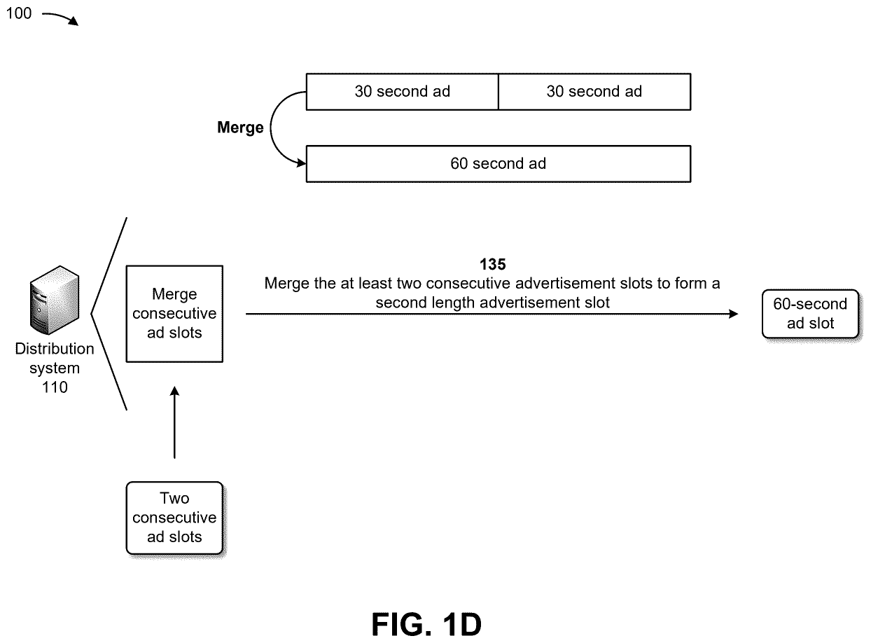

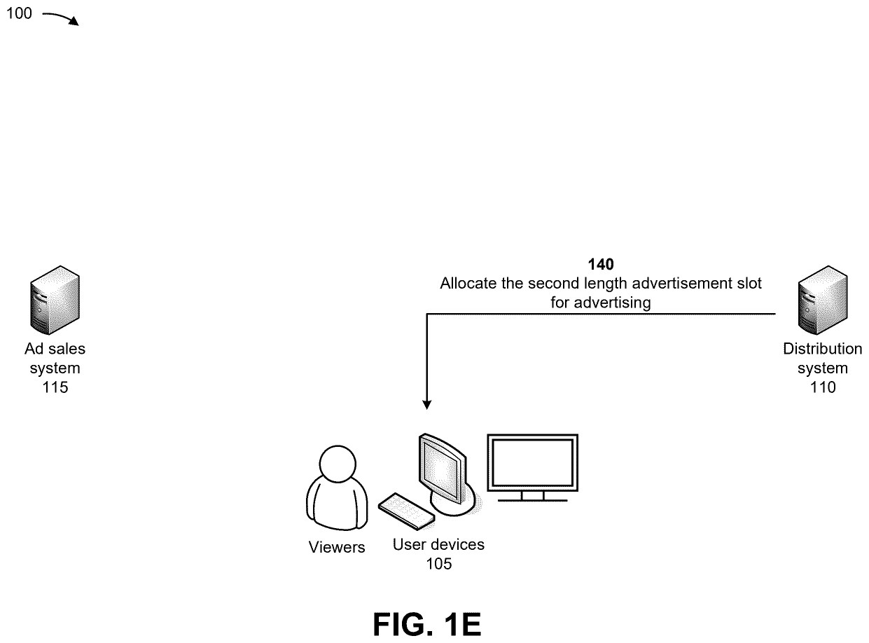

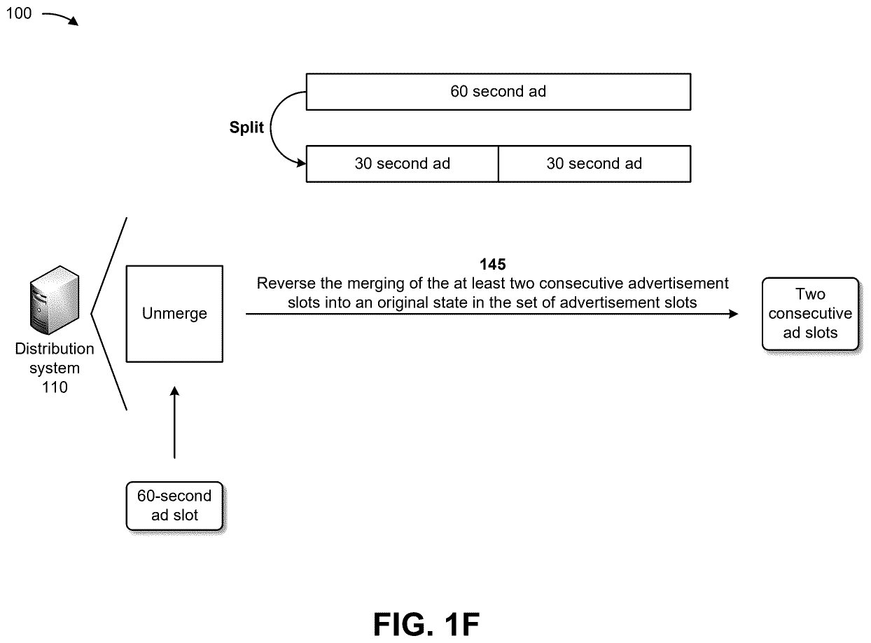

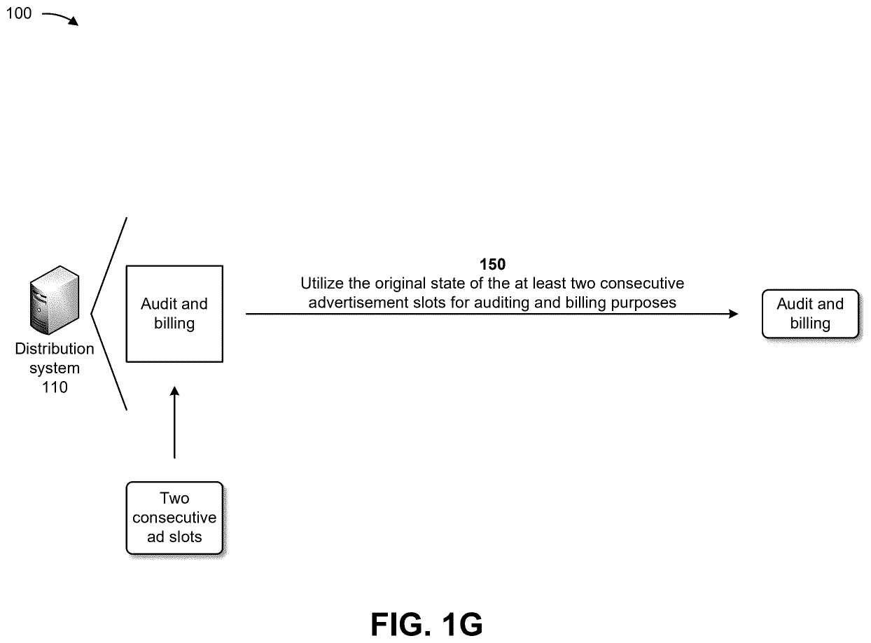

FIGS. 1A-1G are diagrams of an example 100 associated with creating advertisement inventory. As shown in FIGS. 1A-1G, the example 100 includes user devices 105 associated with viewers, a distribution system 110, and an advertisement (ad) sales system 115. The viewers may utilize the user device 105 to view content and advertisements provided by the distribution system 110. The distribution system 110 may include a system that creates advertisement inventory. The ad sales system 115 may include a system that enables sales of advertisement slots. Further details of the user devices 105, the distribution system 110, and the ad sales system 115 are provided elsewhere herein.

As shown in FIG. 1A, and by reference number 120, the distribution system 110 may receive advertisement inventory data associated with a content broadcast and including a plurality of advertisement slots. For example, the distribution system 110 may be associated with distributors that sell advertisement breaks to advertisers. Often, the advertising sales in any particular market may be performed by a single sales entity associated with the ad sales system 115. Sold advertisement slots may be provided to the distribution system 110 in a standard form (e.g., a communication, collaboration, and meeting solutions (CCMS) schedule file) which specifies a specific time an advertisement slot is scheduled to play, as well as a complete order of all advertisement slots for a day within content of the day. The ad sales system 115 may be responsible for allocating advertisement breaks into an advertisement inventory where some advertisement breaks are for sale and some are restricted to marketing use by the distributor. Further, since the marketing allocation is often used by the distributor to place company marketing advertisements, user experience requirements dictate that individual marketing advertisements may not be placed back-to-back. The CCMS schedule file may identify a sold advertisement at a specific time by the name of the advertisement and advertiser and may identify the marketing advertisements by a special marketing placeholder identifier. The remainder of the advertisement inventory in the CCMS schedule file may be filled with low value advertisements (e.g., advertisements with a value below a predetermined value). In summary, the advertisement schedule may include a combination of sold, high value (e.g., above a predetermined values) advertisements (e.g., with durations of lengths, such as fifteen, thirty, and sixty seconds), sold, low value advertisements (e.g., with durations of lengths, such as thirty and sixty seconds), and marketing advertisements (e.g., with durations of lengths, such as thirty seconds).

In some implementations, the ad sales system 115 may generate the advertisement inventory data associated with a content broadcast and including a plurality of advertisement slots. The advertisement inventory data may include data that identifies various advertisement slots within a scheduled content broadcast. The plurality of advertisement slots may include different types “sold—high value” slots, “sold—low value” slots, and “unsold” slots. The plurality of advertisement slots may also vary in duration. For example, as shown in FIG. 1A, the advertisement slots may include fifteen-second slots, thirty-second slots, sixty-second slots, and/or the like. The ad sales system 115 may provide the advertisement inventory data to the distribution system 110, and the distribution system 110 may receive the advertisement inventory data from the ad sales system 115.

In some implementations, the distribution system 110 may receive advertisement inventory data from multiple ad sales systems 115 and may compile a comprehensive overview of available advertisement slots across various networks. This may enable a broader range of advertisement opportunities and may ensure that advertisement inventory data from disparate sources is consolidated into a single management system (e.g., the distribution system 110). Additionally, or alternatively, the advertisement inventory data may include metadata, such as historical viewership statistics or anticipated audience demographics to aid in optimizing advertisement slot allocation. The metadata may enable the distribution system 110 to tailor advertisements to likely viewers, maximizing the impact and relevance of the advertisements.

Additionally, or alternatively, the distribution system 110 and the ad sales system 115 may utilize secure data protocols during transmission of the advertisement inventory data to ensure the integrity and confidentiality of the advertisement inventory data. Ensuring data security may prevent unauthorized access and may maintain the trust of all parties involved in the advertisement process. Additionally, or alternatively, the distribution system 110 may periodically update the advertisement inventory data to reflect real-time changes in advertisement slot availability or sales status. This may ensure that the most current advertisement inventory data is always available for making advertisement decisions.

Additionally, or alternatively, the distribution system 110 may analyze the advertisement inventory data to predict future demand for different advertisement slot durations. By anticipating trends, the distribution system 110 may better prepare and allocate resources for upcoming advertising needs. Additionally, or alternatively, the distribution system 110 may integrate the advertisement inventory data with third-party analytics to provide enhanced insights into advertisement performance. Third-party analytics may offer additional perspectives and metrics that complement the advertisement inventory data.

As shown in FIG. 1B, and by reference number 125, the distribution system 110 may identify, from the plurality of advertisement slots, a set of advertisement slots having durations of first lengths (e.g., thirty seconds or less according to exemplary embodiments) and being designated as unsold or sold below a threshold value. For example, the distribution system 110 may analyze the advertisement inventory data received from the ad sales system 115. During the analysis, the distribution system 110 may examine the duration of each of the plurality of advertisement slots to determine whether the examined slot is thirty seconds or less, and may check a sale status of the examined slot to determine whether the examined slot is unsold or sold below a predefined threshold value. The distribution system 110 may allocate, to the set of advertisement slots, any of the plurality of advertisement slots that include a duration of thirty seconds or less and are designated as unsold or sold below the threshold value. This may enable the distribution system 110 to identify low-value or unsold advertisement slots that can be repurposed for high-value addressable advertising. By doing so, the distribution system 110 may effectively enhance the utilization of available advertisement slots.

In some implementations, the distribution system 110 may identify advertisement slots of various durations (e.g., such as fifteen seconds, and not just those of thirty seconds or less) and that are designated as unsold or sold below the threshold value. This may enable the distribution system 110 to capture a broader range of opportunities for repurposing underutilized advertisement slots. Additionally, or alternatively, the distribution system 110 may utilize historical sales data to determine which advertisement slots are likely to remain unsold or sold below the threshold, thereby allowing for more proactive slot identification. For example, advertisement slots that have historically performed poorly in terms of sales may be flagged for repurposing. Additionally, or alternatively, instead of relying solely on sales status, the distribution system 110 may incorporate additional criteria such as viewer engagement metrics to assess the potential value of retaining or repurposing specific advertisement slots. Viewer engagement metrics may provide insights into which advertisement slots are more impactful, even if they are unsold or undervalued in terms of sales.

Additionally, or alternatively, the distribution system 110 may integrate real-time updates from the ad sales system 115 to dynamically adjust the identification of the set of advertisement slots based on latest sales and viewership data. Real-time data integration may ensure that the identification process is always based on the most current information. Additionally, or alternatively, the identification of the set of advertisement slots may be enhanced by incorporating predictive analytics to forecast future demand for certain advertisement slot durations and to adjust the identification criteria accordingly. Predictive analytics may anticipate market trends and may optimize the selection of advertisement slots for repurposing. Additionally, or alternatively, the advertisement slots identified for the set of advertisement slots may also include the advertisement slots designated for internal marketing purposes, allowing for strategic reallocation. This may enable the distribution system 110 to make the best use of available advertisement slots for both internal and external advertising needs.

As shown in FIG. 1C, and by reference number 130, the distribution system 110 may select at least two consecutive advertisement slots within an advertisement break and from the set of advertisement slots. For example, the distribution system 110 may review the set of advertisement slots that include the duration of the first lengths (e.g., thirty seconds or less) and are designated as unsold or sold below the threshold value. Based on the review, the distribution system 110 may select two or more consecutive advertisement slots that are available within a specific advertisement break, ensuring the selected advertisement slots satisfy the criteria for merging into a longer advertisement slot. In some implementations, selecting the at least two consecutive advertisement slots may include selecting the at least two consecutive advertisement slots based on historical viewership data, ensuring that the selected advertisement slots are optimized for maximum audience engagement. By analyzing past viewership patterns, the distribution system 110 may identify advertisement slots that have historically captured the most audience attention, thereby increasing the likelihood of advertisement effectiveness.

Additionally, or alternatively, the distribution system 110 may prioritize advertisement slots that historically show lower viewer drop-off rates, thus potentially increasing the effectiveness of the advertisements. This may ensure that the selected advertisement slots maintain a steady viewership, and may maximize the impact of the advertisements. Additionally, or alternatively, the distribution system 110 may utilize a machine learning model to predict the best consecutive advertisement slots to select, taking into account factors such as viewer demographics, time of day, and content genre. The machine learning model may dynamically adjust the selection process to align with current trends and preferences, enhancing the overall strategy for advertisement placement. Additionally, or alternatively, the distribution system 110 may utilize real-time data analytics to dynamically adjust the selection of the two consecutive advertisement slots, ensuring that the highest value advertisement slots are always selected based on current viewer metrics and market conditions. This real-time adaptability may enable the distribution system 110 to respond to immediate changes in viewership patterns.

As shown in FIG. 1D, and by reference number 135, the distribution system 110 may merge the at least two consecutive advertisement slots to form a sixty-second (according to some exemplary embodiments) advertisement slot. For example, the distribution system 110 may combine the at least two advertisement slots, each having a duration of thirty seconds (for example) or less, into a single cohesive advertisement slot with a duration of sixty seconds. The distribution system 110 may determine a temporal alignment of the at least two consecutive advertisement slots and may ensure that the resulting second length advertisement slot maintains a seamless transition between the at least two consecutive advertisement slots. The at least two consecutive advertisement slots may be merged to accommodate advertisements that require a sixty-second advertisement slot duration, thus addressing the need for longer advertisement formats that are increasingly demanded by advertisers. By merging the at least two consecutive advertisement slots, the distribution system 110 may effectively increase the value and flexibility of the advertisement inventory, enabling the delivery of targeted, high-value advertising while optimizing existing resources.

In some implementations, the distribution system 110 may utilize a software model specifically designed for temporal synchronization and alignment of advertisement content to merge the at least two consecutive advertisement slots and form a seamless second length advertisement slot. The software model may ensure that transitions between the merged slots of at least two consecutive advertisement slots are imperceptible to viewers, thus enhancing the overall advertisement experience.

As shown in FIG. 1E, and by reference number 140, the distribution system 110 may allocate the second length advertisement slot for advertising. For example, the distribution system 110 may allocate the second length advertisement slot for advertising that is broadcast to viewers associated with the user devices 105. In some implementations, the distribution system 110 may utilize the second length advertisement slot to broadcast targeted content based on demographic data associated with the content broadcast. This allocation may enable advertisers to deliver tailored advertisements to specific viewer demographics, enhancing the relevance and effectiveness of the advertising content. By targeting advertisements to the appropriate audience, the distribution system 110 may optimize advertising impact and maximize revenue opportunities for advertisers. Additionally, or alternatively, the distribution system 110 may allocate the second length advertisement slot for personalized advertising, allowing advertisers to reach specific viewer segments based on demographic information associated with the content broadcast. For example, the distribution system 110 may use the allocated second length advertisement slot to disseminate content tailored to the interests and preferences of the viewing audience as determined by demographic data.

Additionally, or alternatively, the allocation of the second length advertisement slot for targeted advertising may enable the distribution system 110 to optimize the use of existing advertisement inventory, thereby enhancing the efficiency of resource management within the advertising framework. Additionally, the second length advertisement slot allocation for advertising may enable the distribution system 110 to achieve better audience engagement metrics by ensuring the content is aligned with viewer interests. The distribution system 110 may also leverage the allocated second length advertisement slot to execute data-driven advertising strategies, focusing on audience behaviors and preferences to improve advertisement performance. By allocating the sixty-second slot for advertising, the distribution system 110 may support advertisers in achieving higher conversion rates by focusing on delivering advertisements to an audience with a higher likelihood of engagement.

As shown in FIG. 1F, and by reference number 145, the distribution system 110 may reverse the merging of the at least two consecutive advertisement slots into an original state in the set of advertisement slots. For example, the distribution system 110 may unmerge a previously combined second length advertisement slot back into the original at least two consecutive advertisement slots. The distribution system 110 may unmerge the sixty-second advertisement slot by splitting the sixty-second advertisement slot into the at least two distinct advertisement slots, as initially configured before the merging process. This unmerging of the sixty-second advertisement slot may be utilized for maintaining accurate records of advertisement inventory and ensuring compliance with advertising agreements. For example, the unmerging of the sixty-second advertisement slot enables the distribution system 110 to provide accurate verification and billing information to advertisers and sales partners who require detailed tracking of advertisement slot usage. By returning the at least two consecutive advertisement slots into the original state in the set of advertisement slots, the distribution system 110 may effectively manage and audit the advertisement inventory, ensuring transparency and accountability in advertisement allocation.

In some implementations, the distribution system 110 may separate the sixty-second advertisement slot back into original fifteen-second and/or thirty-second advertisement slots depending on the initial configuration prior to merging. For example, if the original configuration included a combination of two thirty-second advertisement slots, the distribution system 110 may restore the sixty-second advertisement slot to two distinct thirty-second advertisement slots. Similarly, if the original configuration included a combination of four fifteen-second advertisement slots or a mix of one thirty-second advertisement slot and two fifteen-second advertisement slots, the distribution system 110 may reestablish these specific durations.

As shown in FIG. 1G, and by reference number 150, the distribution system 110 may utilize the original state of the at least two consecutive advertisement slots for auditing and billing purposes. For example, the distribution system 110 may provide accurate verification and billing information to advertisers and sales partners by utilizing the original state of the at least two consecutive advertisement slots. This may ensure transparency and accountability in advertisement allocation, as the original configuration of the advertisement slots can be used to audit and verify the changes made during the advertising process. By reverting the advertisement slots to their original state, the distribution system 110 may maintain compliance with advertising agreements and may supports accurate record-keeping, thereby enhancing the reliability of the billing process and ensuring that all parties involved receive correct compensation based on actual advertisement slot usage.

In some implementations, the distribution system 110 may utilize metadata associated with the at least two consecutive advertisement slots to provide accurate verification and billing information to advertisers and sales partners. Utilizing the metadata may enable the distribution system 110 to maintain a digital record of advertisement slot changes, which can be easily accessed and reviewed for auditing purposes without reverting the slots to their original state.

In some implementations, the distribution system 110 may verify an original state of the at least two consecutive advertisement slots after an advertisement is played in the second length advertisement slot, and may store metadata associated with the second length advertisement slot. For example, the metadata may include viewership statistics for the sixty-second advertisement slot, advertisement performance for the sixty-second advertisement slot, and/or the like. In some implementations, the advertisement break may include multiple advertisement slots of varying durations, and the distribution system 110 may evaluate the advertisement break to identify other configurations for advertisement slots. In some implementations, the distribution system 110 may generate, for the advertisement break, a schedule that includes the second length advertisement slot.

In this way, the distribution system 110 creates advertisement inventory. For example, the distribution system 110 may address the problem of limited inventory for sixty-second advertisement slots. The distribution system 110 may optimize the utilization of existing advertisement inventory by repurposing unsold or low-value advertisement slots (e.g., below a predetermined value), thus reducing wasted broadcasting resources. The merging and allocation of advertisement slots by the distribution system 110 may decrease processing overhead associated with managing fragmented advertisement slots and may improve storage efficiency by consolidating metadata related to the merged advertisement slots. Furthermore, the verification and reversibility of merged advertisement slots by the distribution system 110 may enhance the accuracy of auditing and billing processes without requiring additional processing or memory resources. Thus, the distribution system 110 may conserve computing resources, networking resources, and/or other resources that would have otherwise been consumed by failing to comply with sales agreements, providing a poor viewer experience for advertisements, failing to satisfy the growing demand for longer, addressable advertisements, managing fragmented advertising inventory, performing redundant validation processes, and/or the like.

As indicated above, FIGS. 1A-1G are provided as an example. Other examples may differ from what is described with regard to FIGS. 1A-1G. The number and arrangement of devices shown in FIGS. 1A-1G are provided as an example. In practice, there may be additional devices, fewer devices, different devices, or differently arranged devices than those shown in FIGS. 1A-1G. Furthermore, two or more devices shown in FIGS. 1A-1G may be implemented within a single device, or a single device shown in FIGS. 1A-1G may be implemented as multiple, distributed devices. Additionally, or alternatively, a set of devices (e.g., one or more devices) shown in FIGS. 1A-1G may perform one or more functions described as being performed by another set of devices shown in FIGS. 1A-1G.

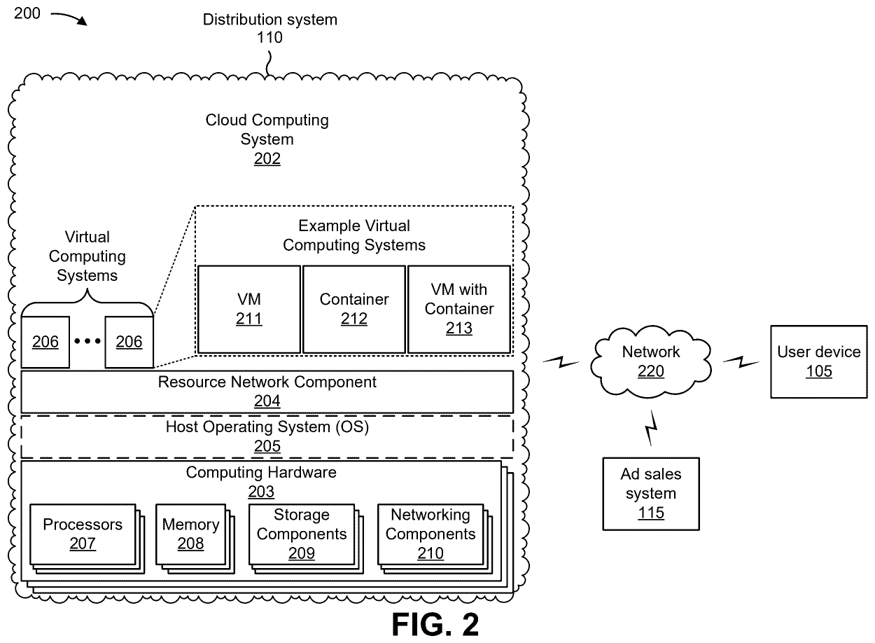

FIG. 2 is a diagram of an example environment 200 in which systems and/or methods described herein may be implemented. As shown in FIG. 2, the environment 200 may include the distribution system 110, which may include one or more elements of and/or may execute within a cloud computing system 202. The cloud computing system 202 may include one or more elements 203-213, as described in more detail below. As further shown in FIG. 2, the environment 200 may include the user device 105, the ad sales system 115, and/or a network 220. Devices and/or elements of the environment 200 may interconnect via wired connections and/or wireless connections.

The user device 105 may include one or more devices capable of receiving, generating, storing, processing, and/or providing information, as described elsewhere herein. The user device 105 may include a communication device and/or a computing device. For example, the user device 105 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The ad sales system 115 may include one or more devices capable of receiving, generating, storing, processing, providing, and/or routing information, as described elsewhere herein. The ad sales system 115 may include a communication device and/or a computing device. For example, the ad sales system 115 may include a server, such as an application server, a client server, a web server, a database server, a host server, a proxy server, a virtual server (e.g., executing on computing hardware), or a server in a cloud computing system. In some implementations, the ad sales system 115 may include computing hardware used in a cloud computing environment, such as one or more serverless components (e.g., one or more serverless functions).

The cloud computing system 202 includes computing hardware 203, a resource management component 204, a host operating system (OS) 205, and/or one or more virtual computing systems 206. The cloud computing system 202 may execute on, for example, an Amazon Web Services platform, a Microsoft Azure platform, or a Snowflake platform. The resource management component 204 may perform virtualization (e.g., abstraction) of the computing hardware 203 to create the one or more virtual computing systems 206. Using virtualization, the resource management component 204 enables a single computing device (e.g., a computer or a server) to operate like multiple computing devices, such as by creating multiple isolated virtual computing systems 206 from the computing hardware 203 of the single computing device. In this way, the computing hardware 203 can operate more efficiently, with lower power consumption, higher reliability, higher availability, higher utilization, greater flexibility, and lower cost than using separate computing devices.

The computing hardware 203 includes hardware and corresponding resources from one or more computing devices. For example, the computing hardware 203 may include hardware from a single computing device (e.g., a single server) or from multiple computing devices (e.g., multiple servers), such as multiple computing devices in one or more data centers. As shown, the computing hardware 203 may include one or more processors 207, one or more memories 208, one or more storage components 209, and/or one or more networking components 210. Examples of a processor, a memory, a storage component, and a networking component (e.g., a communication component) are described elsewhere herein.

The resource management component 204 includes a virtualization application (e.g., executing on hardware, such as the computing hardware 203) capable of virtualizing computing hardware 203 to start, stop, and/or manage one or more virtual computing systems 206. For example, the resource management component 204 may include a hypervisor (e.g., a bare-metal or Type 1 hypervisor, a hosted or Type 2 hypervisor, or another type of hypervisor) or a virtual machine monitor, such as when the virtual computing systems 206 are virtual machines 211. Additionally, or alternatively, the resource management component 204 may include a container manager, such as when the virtual computing systems 206 are containers 212. In some implementations, the resource management component 204 executes within and/or in coordination with a host operating system 205.

A virtual computing system 206 includes a virtual environment that enables cloud-based execution of operations and/or processes described herein using the computing hardware 203. As shown, the virtual computing system 206 may include a virtual machine 211, a container 212, or a hybrid environment 213 that includes a virtual machine and a container, among other examples. The virtual computing system 206 may execute one or more applications using a file system that includes binary files, software libraries, and/or other resources required to execute applications on a guest operating system (e.g., within the virtual computing system 206) or the host operating system 205.

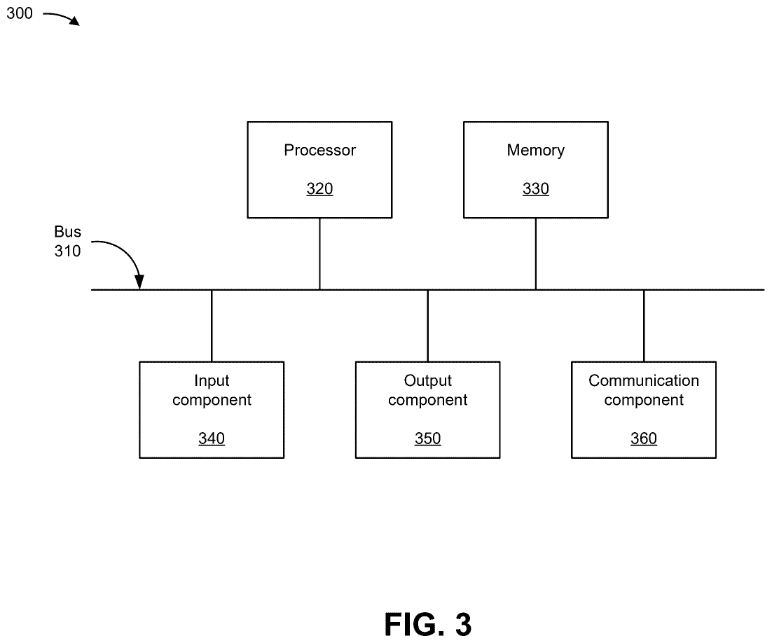

Although the distribution system 110 may include one or more elements 203-213 of the cloud computing system 202, may execute within the cloud computing system 202, and/or may be hosted within the cloud computing system 202, in some implementations, the distribution system 110 may not be cloud-based (e.g., may be implemented outside of a cloud computing system) or may be partially cloud-based. For example, the distribution system 110 may include one or more devices that are not part of the cloud computing system 202, such as a device 300 of FIG. 3, which may include a standalone server or another type of computing device. The distribution system 110 may perform one or more operations and/or processes described in more detail elsewhere herein.

The network 220 includes one or more wired and/or wireless networks. For example, the network 220 may include a cellular network, a public land mobile network (PLMN), a local area network (LAN), a wide area network (WAN), a private network, the Internet, and/or a combination of these or other types of networks. The network 220 enables communication among the devices of the environment 200. In some implementations, the network 220 includes a network capable of providing network slices, such as a 5G core network.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

FIG. 3 is a diagram of example components of a device 300, which may correspond to the user device 105, the distribution system 110, and/or ad sales system 115. In some implementations, the user device 105, the distribution system 110, and/or the ad sales system 115 may include one or more devices 300 and/or one or more components of the device 300. As shown in FIG. 3, the device 300 may include a bus 310, a processor 320, a memory 330, an input component 340, an output component 350, and a communication component 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit, a graphics processing unit, a microprocessor, a controller, a microcontroller, a digital signal processor, a field-programmable gate array, an application-specific integrated circuit, and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

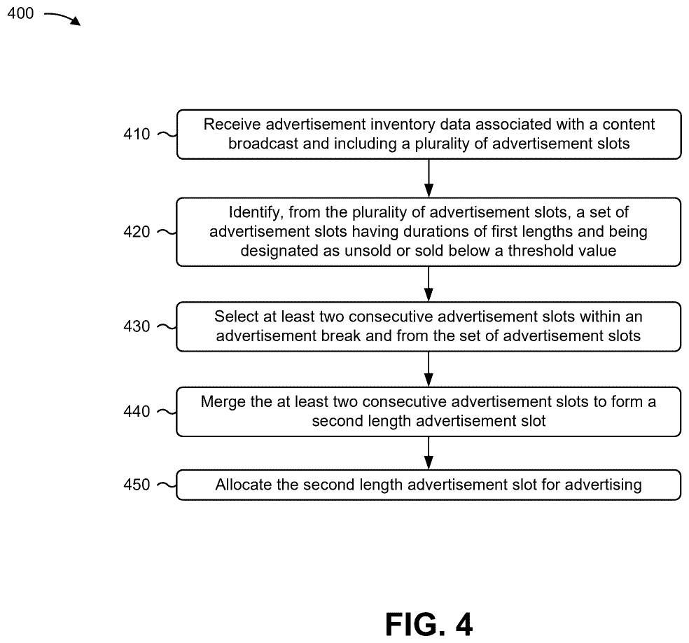

FIG. 4 depicts a flowchart of an example process 400 for creating advertisement inventory. In some implementations, one or more process blocks of FIG. 4 may be performed by a device (e.g., the distribution system 110). In some implementations, one or more process blocks of FIG. 4 may be performed by another device or a group of devices separate from or including the device, such as a user device (e.g., the user device 105). Additionally, or alternatively, one or more process blocks of FIG. 4 may be performed by one or more components of the device 300, such as the processor 320, the memory 330, the input component 340, the output component 350, and/or the communication component 360.

As shown in FIG. 4, process 400 may include receiving advertisement inventory data associated with a content broadcast and including a plurality of advertisement slots (block 410). For example, the device may receive advertisement inventory data associated with a content broadcast and including a plurality of advertisement slots, as described above.

As further shown in FIG. 4, process 400 may include identifying, from the plurality of advertisement slots, a set of advertisement slots having durations of first lengths and being designated as unsold or sold below a threshold value (block 420). For example, the device may identify, from the plurality of advertisement slots, a set of advertisement slots having durations of first lengths and being designated as unsold or sold below a threshold value, as described above.

As further shown in FIG. 4, process 400 may include selecting at least two consecutive advertisement slots within an advertisement break and from the set of advertisement slots (block 430). For example, the device may select at least two consecutive advertisement slots within an advertisement break and from the set of advertisement slots, as described above. In some implementations, selecting the at least two consecutive advertisement slots includes selecting the at least two consecutive advertisement slots based on historical viewership data associated with the content broadcast. In some implementations, each of the at least two consecutive advertisement slots has a duration of thirty seconds. In some implementations, each of the at least two consecutive advertisement slots has a duration of fifteen seconds. In some implementations, two of the at least two consecutive advertisement slots have a duration of fifteen seconds and one of the at least two consecutive advertisement slots has a duration of thirty seconds.

As further shown in FIG. 4, process 400 may include merging the at least two consecutive advertisement slots to form a second length advertisement slot (block 440). For example, the device may merge the at least two consecutive advertisement slots to form a second length advertisement slot, as described above.

As further shown in FIG. 4, process 400 may include allocating the second length advertisement slot for advertising (block 450). For example, the device may allocate the second length advertisement slot for advertising, as described above. In some implementations, the advertising includes an advertisement requiring a sixty-second advertisement slot duration.

In some implementations, process 400 includes utilizing the second length advertisement slot to broadcast targeted content based on demographic data associated with the content broadcast. In some implementations, process 400 includes verifying an original state of the at least two consecutive advertisement slots after an advertisement is played in the second length advertisement slot. In some implementations, process 400 includes storing metadata associated with the second length advertisement slot, wherein the metadata includes at least viewership statistics and advertisement performance. In some implementations, process 400 includes reversing the merging of the at least two consecutive advertisement slots into an original state in the set of advertisement slots, and utilizing the original state of the at least two consecutive advertisement slots for auditing and billing purposes.

In some implementations, the advertisement break includes multiple advertisement slots of varying durations, and process 400 includes evaluating the advertisement break to identify other configurations for advertisement slots. In some implementations, process 400 includes generating, for the advertisement break, a schedule that includes the second length advertisement slot. In some implementations, process 400 includes determining an effectiveness of the second length advertisement slot based on viewer engagement metrics.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

As used herein, “selectively” performing an operation means to either perform the operation or refrain from performing the operation. For example, selectively performing an operation based on whether a condition is satisfied means that the operation is performed if the condition is satisfied and that the operation is not performed if the condition is not satisfied (or vice versa). Thus, selectively performing an operation may include determining whether to perform the operation and then either performing the operation or refraining from performing the operation based on that determination.

As used herein, “selectively” performing a first operation or a second operation means to perform either the first operation or the second operation. For example, selectively performing a first operation or a second operation based on whether a condition is satisfied means that the first operation is performed if the condition is satisfied and that the second operation is performed if the condition is not satisfied (or vice versa). Thus, selectively performing a first operation or a second operation may include determining whether to perform either the first operation or the second operation and then performing either the first operation or the second operation based on that determination.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

1. A method, comprising:
receiving, by a device, advertisement inventory data associated with a content broadcast and including a plurality of advertisement slots;
identifying, by the device and from the plurality of advertisement slots, a set of advertisement slots having durations of first lengths and being designated as unsold or sold below a threshold value;
selecting, by the device, at least two consecutive advertisement slots within an advertisement break and from the set of advertisement slots;
merging, by the device, the at least two consecutive advertisement slots, based on a temporal alignment of the at least two consecutive advertisement slots and using temporal synchronization and alignment of advertisement content, to form a second length advertisement slot;
generating, by the device and for the advertisement break, a schedule that includes the second length advertisement slot;
allocating, by the device, the second length advertisement slot for advertising; and
broadcasting, by the device, the advertisement content in the second length advertisement slot.

2. The method of claim 1, wherein selecting the at least two consecutive advertisement slots comprises:
selecting the at least two consecutive advertisement slots based on historical viewership data associated with the content broadcast.

3. The method of claim 1, wherein each of the at least two consecutive advertisement slots has a duration of thirty seconds.

4. The method of claim 1, wherein each of the at least two consecutive advertisement slots has a duration of fifteen seconds.

5. The method of claim 1, wherein two of the at least two consecutive advertisement slots have a duration of fifteen seconds and one of the at least two consecutive advertisement slots has a duration of thirty seconds.

6. The method of claim 1, wherein the advertising includes an advertisement requiring a sixty-second advertisement slot duration.

7. The method of claim 1, wherein broadcasting the advertisement content comprises:
broadcasting targeted content based on demographic data associated with the content broadcast.

8. A device, comprising:
one or more processors configured to:
receive advertisement inventory data associated with a content broadcast and including a plurality of advertisement slots;
identify, from the plurality of advertisement slots, a set of advertisement slots having durations of first lengths and being designated as unsold or sold below a threshold value;
select, based on historical viewership data associated with the content broadcast, at least two consecutive advertisement slots within an advertisement break and from the set of advertisement slots;
merge the at least two consecutive advertisement slots, based on a temporal alignment of the at least two consecutive advertisement slots and using temporal synchronization and alignment of advertisement content, to form a second length advertisement slot;
generate, for the advertisement break, a schedule that includes the second length advertisement slot;
allocate the second length advertisement slot for advertising; and
broadcast the advertisement content in the second length advertisement slot.

9. The device of claim 8, wherein the one or more processors are further configured to:
verify an original state of the at least two consecutive advertisement slots after the advertisement content is broadcast in the second length advertisement slot.

10. The device of claim 8, wherein the one or more processors are further configured to:
store metadata associated with the second length advertisement slot,
wherein the metadata includes at least viewership statistics and advertisement performance.

11. The device of claim 8, wherein the one or more processors are further configured to:
reverse the merging of the at least two consecutive advertisement slots to restore the at least two consecutive advertisement slots to an original state in the set of advertisement slots; and
utilize the original state of the at least two consecutive advertisement slots for auditing and billing purposes.

12. The device of claim 8, wherein the advertisement break includes multiple advertisement slots of varying durations, and the one or more processors are further configured to:
evaluate the advertisement break to identify other configurations for advertisement slots.

13. (canceled)

14. The device of claim 8, wherein the one or more processors are further configured to:
determine an effectiveness of the second length advertisement slot based on viewer engagement metrics.

15. A non-transitory computer-readable medium storing a set of instructions, the set of instructions comprising:
one or more instructions that, when executed by one or more processors of a device, cause the device to:
receive advertisement inventory data associated with a content broadcast and including a plurality of advertisement slots;
identify, from the plurality of advertisement slots, a set of advertisement slots having durations of first lengths and being designated as unsold or sold below a threshold value;
select at least two consecutive advertisement slots within an advertisement break and from the set of advertisement slots;
merge the at least two consecutive advertisement slots, based on a temporal alignment of the at least two consecutive advertisement slots and using temporal synchronization and alignment of advertisement content, to form a second length advertisement slot;
generate, for the advertisement break, a schedule that includes the second length advertisement slot;
allocate the second length advertisement slot for advertising;
broadcast the advertisement content in the second length advertisement slot; and
verify an original state of the at least two consecutive advertisement slots after the advertisement content is broadcast in the second length advertisement slot.

16. The non-transitory computer-readable medium of claim 15, wherein the one or more instructions, that cause the device to select the at least two consecutive advertisement slots, cause the device to:
select the at least two consecutive advertisement slots based on historical viewership data associated with the content broadcast.

17. The non-transitory computer-readable medium of claim 15, wherein the one or more instructions further cause the device to:
broadcast targeted content, as the advertisement content based on demographic data associated with the content broadcast.

18. The non-transitory computer-readable medium of claim 15, wherein the one or more instructions further cause the device to:
store metadata associated with the second length advertisement slot,
wherein the metadata includes at least viewership statistics and advertisement performance.

19. (canceled)

20. The non-transitory computer-readable medium of claim 15, wherein the one or more instructions further cause the device to:
determine an effectiveness of the second length advertisement slot based on viewer engagement metrics.

21. The method of claim 1, further comprising:
updating, by the device, the advertisement inventory data to reflect real-time changes in advertisement slot availability or sales status.

22. The device of claim 8, wherein the one or more processors are further configured to:
update the advertisement inventory data to reflect real-time changes in advertisement slot availability or sales status.
